(19) United States
(12) Patent Application Publication
(10) Pub. No.: US 2009/0010537 A1
(43) Pub. Date: Jan. 8, 2009

(54) IMAGE DISPLAY PROCESSING APPARATUS, IMAGE DISPLAY SYSTEM, AND IMAGE DISPLAY PROCESSING METHOD

(75) Inventors: Takuji Horie, Kanagawa (JP); Hiroyuki Fukuda, Tokyo (JP); Akira Matsushita, Tokyo (JP); Takeyuki Ajito, Tokyo (JP); Yasuhiro Komiya, Tokyo (JP); Ken Ioka, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 12/166,823

(22) Filed: Jul. 2, 2008

(30) Foreign Application Priority Data
Jul. 6, 2007 (JP) 2007-178338

(51) Int. Cl. G06K 9/00; H04N 5/228

(52) U.S. Cl. 382/167; 348/222.1; 348/E05.031

(57) ABSTRACT

An image display processing apparatus receives input illuminant information relating to input illuminant illuminating object when photographing, input device information specifying input characteristic of a photographing device, and image signal. Spectral reflectance image signal of the object is obtained from the image signal, the input illuminant information, and the input device information. Rendering light is applied to the spectral reflectance image signal, and output to a display device. A spectrum of light emitted from a variable characteristic illumination device for illuminating a display viewing environment can be varied. Spectrum of observing illuminant illuminating the display viewing environment is measured by a spectrometer unit. A spectrum of the rendering light is determined to substantially match with a spectrum of the input illuminant. The spectrum of the light emitted from the variable characteristic illumination device may be adjusted to substantially match the spectra of both the rendering light and the observing illuminant.

### FIELD OF THE INVENTION

This invention relates to an image display processing apparatus for displaying an image using a color monitor display device, an image display system, and an image display processing method.

### DESCRIPTION OF THE RELATED ART

There has been known the following method of representing a multicolor image with at least three primary colors to enable more faithful and natural color reproduction. In the method, an object is photographed using a camera capable of performing multi-band photographing, for example, 16-band color photographing, which is called a multi-spectral camera. The obtained image data, characteristics of the camera for photographing, and spectral characteristics of illuminating light for illuminating the object at the time of photographing are used to produce an image signal represented by a spectral reflectance of the object. The image signal represented by the spectral reflectance of the object is called a spectral reflectance image signal. The image of the object is displayed on a monitor display device which will be observed in an environment. Color visibility of the object in a case where the object is placed in the environment is calculated (simulated) based on spectral characteristics of illuminating light in the environment and then displayed. In other words, the color visibility of the object is simulated and then displayed by applying a specific spectral characteristic of an illuminating light to the spectral reflectance image signal. The illumination applied to this case is referred to as rendering illumination.

The environment in which the monitor display device which displays the image of the object is observed, for example, a room is illuminated with light from an illumination device provided in the room or light entering from the outside through a window. Hereinafter, the environment in which the image displayed on the monitor display device is observed is referred to as observation environment. The illumination device provided in the observation environment is referred to as environment illuminating device. A combination of the light from the environment illuminating device and the light entering from the outside through the window is referred to as environment illuminant.

In the method described above, a spectrum of the environment illuminant is measured and the rendering illumination is processed in association with the spectrum of the environment illuminant. According to the use of the method, the image of the object, photographed under illumination light having different spectrum from the environment illuminant, can be displayed as if the object is placed in the observation environment. As a result, an observer can observe a more natural image. For example, when the observation environment is illuminated with light emitted from a fluorescent lamp, an image of the object can be displayed on the monitor display device with color as if the object is illuminated with the light emitted from the fluorescent lamp, even in a case where the object is illuminated with tungsten light at the time of photographing.

According to the technique described above, the image of the object is displayed such that the visibility thereof is adjusted corresponding to the observation environment. In other words, the colors of the image to be displayed are converted to match the spectrum of the rendering illuminant with the spectrum of the environment illuminant. In contrast to this, a method using an illumination device for reproducing, which illumination device is an illumination device in which spectral characteristics of emitted light can be changed, is proposed in JP 2005-341122 A. According to this method, when the illumination device for reproducing is provided in the observation environment and light from the illumination device for reproducing is matched in color with light illuminating the object at the time of photographing the object (hereinafter, referred to as input illuminant), the sense of realism at the time of watching, for example, movies can be enhanced. In the method disclosed in JP 2005-341122 A, chromaticity values (x, y, z) of the input illuminant are measured and recorded. The color of the light from the illumination device for reproducing is controlled based on the chromaticity values.

### SUMMARY OF THE INVENTION

According to JP 2005-341122 A, the image is displayed such that a spectral distribution of the rendering illuminant is substantially equal to a spectral distribution of the input illuminant. For example, the image of the object illuminated with tungsten light for photographing is displayed with color corresponding to a state of being illuminated with the tungsten light. The color of the light emitted from the illumination device for reproducing is controlled such that the light from the illumination device for reproducing matches in color with the input illuminant.

However, JP 2005-341122 A does not mention the influence of the external light beams entering the room through the window or the influence of light beams emitted from a light source other than the illumination device for reproducing. Colors of these light beams cannot be controlled. In the observation environment including these light beams, when another illumination light source is turned on or when the external light beams entering through the window is reddened by the decline of the sun, the color of the entire light illuminating the observation environment changes. Therefore, with only the control of the color of the light emitted from the illumination device for reproducing according to the input illuminant as disclosed in JP 2005-341122 A, it may be difficult to match the color of the entire environment illuminant illuminating the observation environment with the color of the input illuminant in the observation environment in which the environment illuminant includes the external light or the light emitted from another light source. When such matching is difficult, it may be difficult to display a realistic image.

This invention has been made to solve the above-mentioned problem, and an object of this invention is therefore to provide a technique capable of displaying an image without reducing the sense of realism even in the observation environment in which the environment illuminant includes the external light or the light emitted from a light source other than the illumination device for reproducing.

A first aspect of this invention is applied to an image display processing apparatus. The image display processing apparatus receives input illuminant information which is information relating to a spectrum of input illuminant illuminating an object during photographing, input device information which is input characteristic information of a photographing device used for the photographing, and an object image signal obtained by photographing the object by the photographing device. Then, a spectral reflectance image signal is obtained based on the object image signal, the input illuminant information, and the input device information. Color conversion processing is performed by applying rendering light having a spectrum substantially matched with the spectrum of the input illuminant to the spectral reflectance image signal to generate an image display signal to be output to a display device. Moreover, a spectrum of light emitted from a variable characteristic illumination device is controlled. The variable characteristic illumination device is configured to illuminate an environment, in which the display device is observed, with light having a desired spectrum. Observing illumination spectrum information is received from a spectrometer unit which measures observing illuminant for illuminating the environment in which the display device is observed and which generates the observing illumination spectrum information, the observing illumination spectrum information being information relating to a spectrum of the observing illuminant. Then, the spectrum of the light emitted from the variable characteristic illumination device is adjusted to substantially match the spectrum of the input illuminant and the spectrum of the observing illuminant.

A second aspect of this invention is applied to an image display processing apparatus. The image display processing apparatus receives input illuminant information which is information relating to a spectrum of input illuminant illuminating an object during photographing, input device information which is input characteristic information of a photographing device used for the photographing, and an object image signal obtained by photographing the object by the photographing device. Then, a spectral reflectance image signal is obtained based on the object image signal, the input illuminant information, and the input device information. Color conversion processing is performed by applying rendering light to the spectral reflectance image signal to generate an image display signal to be output to a display device.

The image display processing apparatus controls a spectrum of light emitted from a variable characteristic illumination device which is configured to illuminate an environment, in which the display device is observed, with light having a desired spectrum,

receives observing illumination spectrum information from a spectrometer unit which measures observing illuminant illuminating the environment in which the display device is observed and which generates the observing illumination spectrum information, the observing illumination spectrum information being information relating to a spectrum of the observing illuminant,

determines a spectrum of the rendering light to substantially match with the spectrum of the input illuminant, and

adjusts the spectrum of the light emitted from the variable characteristic illumination device to substantially match the spectrum of the rendering light with the spectrum of the observing illuminant.

A third aspect of this invention is applied to an image display processing apparatus for performing color conversion on an object image signal obtained by photographing an object by a photographing device and outputting the object image signal to a display device. The image display processing apparatus includes an input profile information separation unit, a signal processing unit, an illumination correction amount calculating unit, and an illumination control unit.

The input profile information separation unit obtains input illuminant information which is information relating to a spectrum of input illuminant illuminating the object during photographing, input device information which is input characteristic information of the photographing device used for the photographing, and the object image signal.

The signal processing unit performs color conversion processing by applying rendering light having a spectrum substantially matched with the spectrum of the input illuminant to a spectral reflectance image signal of the object which is calculated based on the object image signal, the input illuminant information, and the input device information, to generate an image display signal to be output to the display device.

The illumination correction amount calculating unit calculates illumination correction information based on a difference between the input illuminant information output from the input profile information separation unit and observing illumination spectrum information output from a spectrometer unit which measures a spectrum of observing illuminant illuminating an environment in which the display device is observed, the observing illumination spectrum information being information relating to a spectrum of the observing illuminant.

The illumination control unit adjusts a spectrum of light emitted from a variable characteristic illumination device based on the illumination correction information to substantially match the spectrum of the input illuminant and the spectrum of the observing illuminant, the variable characteristic illumination device being configured to illuminate the environment, in which the display device is observed, with light having a desired spectrum.

A fourth aspect of this invention is applied to an image display processing apparatus for performing color conversion on an object image signal obtained by photographing an object by a photographing device and outputting the object image signal to a display device. The image display processing apparatus includes an input profile information separation unit, a signal processing unit, an illumination correction amount calculating unit, and an illumination control unit.

The input profile information separation unit obtains input illuminant information which is information relating to a spectrum of input illuminant illuminating the object during photographing, input device information which is input characteristic information of the photographing device used for the photographing, and the object image signal.

The signal processing unit performs color conversion processing by applying rendering light to a spectral reflectance image signal of the object which is calculated based on the object image signal, the input illuminant information, and the input device information, to generate an image display signal to be output to the display device.

The illumination correction amount calculating unit calculates illumination correction information based on a difference between the input illuminant information output from the input profile information separation unit and observing illumination spectrum information output from a spectrometer unit which measures a spectrum of observing illuminant illuminating an environment in which the display device is observed, the observing illumination spectrum information relating to a spectrum of the observing illuminant, and determines rendering illumination information for controlling a spectrum of the rendering light based on the difference.

The illumination control unit adjusts a spectrum of light emitted from a variable characteristic illumination device based on the illumination correction information to substantially match the spectrum of the rendering light and the spectrum of the observing illuminant, the variable characteristic illumination device being configured to illuminate the environment, in which the display device is observed, with light having a desired spectrum.

A fifth aspect of this invention is applied to an image display system. The image display system includes a display device, an image display processing apparatus, a spectrometer unit, and a variable characteristic illumination device.

The image display processing apparatus performs color conversion on an object image signal obtained by photographing an object by a photographing device and outputs the object image signal to the display device.

The spectrometer unit measures a spectrum of observing illuminant illuminating an environment in which the display device is observed.

The variable characteristic illumination device illuminates the environment, in which the display device is observed, with light having a desired spectrum.

The image display processing apparatus further includes an input profile information separation unit, a signal processing unit, an illumination correction amount calculating unit, and an illumination control unit.

The input profile information separation unit obtains input illuminant information which is information relating to a spectrum of input illuminant illuminating the object during photographing, input device information which is input characteristic information of the photographing device used for the photographing, and the object image signal.

The signal processing unit performs color conversion processing by applying rendering light, having a spectrum substantially matched with the spectrum of the input illuminant, to a spectral reflectance image signal of the object which is calculated based on the object image signal, the input illuminant information, and the input device information, to generate an image display signal to be output to the display device.

The illumination correction amount calculating unit calculates illumination correction information based on a difference between the input illuminant information output from the input profile information separation unit and observing illumination spectrum information which is information relating to the spectrum of the observing illuminant and being output from the spectrometer unit.

The illumination control unit adjusts a spectrum of light emitted from the variable characteristic illumination device based on the illumination correction information to substantially match the spectrum of the input illuminant and the spectrum of the observing illuminant.

A sixth aspect of this invention is applied to an image display system. The image display system includes a display device, an image display processing apparatus, a spectrometer unit, and a variable characteristic illumination device.

The image display processing apparatus performs color conversion on an object image signal obtained by photographing an object by a photographing device and outputs the object image signal to the display device.

The spectrometer unit measures a spectrum of observing illuminant illuminating an environment in which the display device is observed.

The variable characteristic illumination device illuminates the environment, in which the display device is observed, with light having a desired spectrum.

The image display processing apparatus further includes an input profile information separation unit, a signal processing unit, an illumination correction amount calculating unit, and an illumination control unit.

The input profile information separation unit obtains input illuminant information which is information relating to a spectrum of input illuminant illuminating the object during photographing, input device information which is input characteristic information of the photographing device used for the photographing, and the object image signal.

The signal processing unit performs color conversion processing by applying rendering light to a spectral reflectance image signal of the object which is calculated based on the object image signal, the input illuminant information, and the input device information, to generate an image display signal to be output to the display device.

The illumination correction amount calculating unit calculates illumination correction information based on a difference between the input illuminant information output from the input profile information separation unit and observing illumination spectrum information which is information relating to the spectrum of the observing illuminant and being output from the spectrometer unit, and determines rendering illumination information for controlling a spectrum of the rendering light based on the difference.

The illumination control unit adjusts a spectrum of light emitted from the variable characteristic illumination device based on the illumination correction information to substantially match the spectrum of the rendering light and the spectrum of the observing illuminant.

A seventh aspect of this invention is applied to an image display processing method. The image display processing method includes the following steps.

Input illuminant information which is information relating to a spectrum of input illuminant illuminating an object during photographing, input device information which is input characteristic information of a photographing device used for the photographing, and an object image signal obtained by photographing the object by the photographing device are received.

Color conversion processing is performed by applying rendering light, having a spectrum substantially matched with the spectrum of the input illuminant, to a spectral reflectance image signal of the object which is calculated based on the object image signal, the input illuminant information, and the input device information, to generate an image display signal to be output to a display device.

Observing illuminant illuminating an environment in which the display device is observed is measured, to obtain observing illumination spectrum information which is information relating to a spectrum of the observing illuminant.

Then, the spectrum of the input illuminant and the spectrum of the observing illuminant are matched substantially by adjusting a spectrum of light emitted from a variable characteristic illumination device which is configured to illuminate the environment, in which the display device is observed, with light having a desired spectrum.

An eighth aspect of this invention is applied to an image display processing method. The image display processing method includes the following steps.

Input illuminant information which is information relating to a spectrum of input illuminant illuminating an object during photographing, input device information which is input characteristic information of a photographing device used for the photographing, and an object image signal obtained by photographing the object by the photographing device are received.

Color conversion processing is performed by applying rendering light to a spectral reflectance image signal of the object which is calculated based on the object image signal, the input illuminant information, and the input device information, to generate an image display signal to be output to a display device.

Observing illuminant illuminating an environment in which the display device is observed is measured, to obtain observing illumination spectrum information which is information relating to a spectrum of the observing illuminant.

Illumination correction information is calculated based on a difference between the observing illumination spectrum information and the input illuminant information, and rendering illumination information for controlling a spectrum of the rendering light is determined based on the difference.

The spectrum of the input illuminant and the spectrum of the observing illuminant are matched substantially by adjusting a spectrum of light emitted from a variable characteristic illumination device which is configured to illuminate the environment, in which the display device is observed, with light having a desired spectrum.

### BRIEF DESCRIPTION OF THE DRAWINGS

Detailed description of embodiments of the inventions will be made with reference to the accompanying drawings, in which:

FIG. 1 is a schematic explanatory block diagram showing a structure of an image display system according to a first embodiment of this invention;

FIG. 2 is an explanatory block diagram showing internal structural examples of a color conversion processing unit and a monitor color conversion processing unit;

FIG. 3 is a conceptual diagram showing a method of obtaining illumination correction information in an illumination correction amount calculating unit;

FIG. 4 is an explanatory flowchart showing an example of an illumination correction information calculation procedure executed by the illumination correction amount calculating unit;

FIG. 5 is a schematic explanatory block diagram showing a structure of an image display system according to a second embodiment of this invention;

FIG. 6 is a conceptual diagram showing a method of obtaining illumination correction information in an illumination correction amount calculating unit included in the image display system according to the second embodiment of this invention;

FIG. 7 is an explanatory flowchart showing an example of an illumination correction information calculation procedure executed by the illumination correction amount calculating unit included in the image display system according to the second embodiment of this invention;

FIG. 8 is a conceptual diagram showing another example of the method of obtaining the illumination correction information in the illumination correction amount calculating unit included in the image display system according to the second embodiment of this invention; and

FIG. 9 is an explanatory flowchart showing another example of the illumination correction information calculation procedure executed by the illumination correction amount calculating unit included in the image display system according to the second embodiment of this invention.

### DETAILED DESCRIPTION OF THE EMBODIMENTS

### First Embodiment

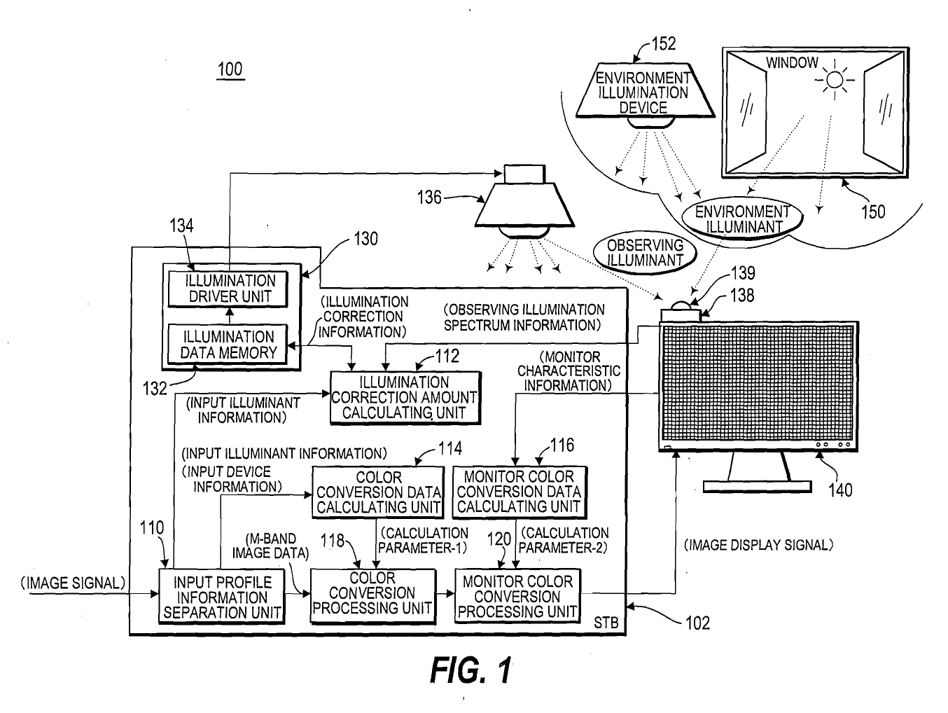

FIG. 1 is a schematic block diagram showing a structure of an image display system according to a first embodiment of this invention. An image display system 100 includes a set top box (hereinafter, referred to as “STB” in this specification) 102, a variable characteristic illumination device 136, a spectrometer unit 138, and a monitor display device (hereinafter, referred to as “display device” in this specification) 140. The image display system 100 is provided in, for example, a room in a house. The room includes an illumination device such as a ceiling light and a window. Light is emitted from the illumination device. For example, sunlight enters into the room through the window. In this embodiment, for example, the room in which the image display system 100 is provided corresponds to an “observation environment” described above. The illumination device which is previously provided in the room or is not included in the image display system 100 corresponds to an “environment illumination device” described above and expressed by reference numeral 152 in FIG. 1. Light entering through a window 150 of the room and light emitted from the environment illumination device 152 correspond to environment illuminant.

The variable characteristic illumination device 136 is controlled by an illumination control unit 130 of the STB 102 which will be described in detail later. As described below, a luminance of light emitted from the variable characteristic illumination device 136 and spectral characteristics thereof can be adjusted. The variable characteristic illumination device 136 includes three or more light sources, desirably six or more light sources being capable of varying their luminances separately and independently. Examples of each of the light sources of the variable characteristic illumination device 136 can include a tungsten lamp, a fluorescent lamp, a light emitting diode (LED), a halogen lamp, and a xenon lamp, which are used as conventional normal illuminating light sources. The respective light sources are attached with color filters whose spectral transmission characteristics are different from one another. For example, when three light sources are to be provided, a first light source is attached with a red color filter, a second light source is attached with a green color filter, and a third light source is attached with a blue color filter. When luminances of light emitted from the first, second and third light sources are separately and independently controlled, characteristics of the light emitted from the variable characteristic illumination device 136, in other words, the luminances and spectral characteristics can be controlled. With regard to each of the color filters, a layer having color filtering function may be directly formed on a light emitting portion of the light source, for example, a surface of a lamp.

When the LED is used as the light source, the color filters may be unnecessary. In this case, a plurality of LEDs whose luminescence spectra are different from one another can be used. For example, a red LED is provided as the first light source, a green LED is provided as the second light source, and a blue LED is provided as the third light source. When the emission luminances of the LEDs are separately and independently adjusted, the characteristics of the light emitted from the variable characteristic illumination device 136 can be controlled.

Further, a device similar to a color liquid crystal display device can also be used as the variable characteristic illumination device 136. In this case, a light source having a relatively wide spectral range and relatively uniform spectral characteristics is used as a backlight for the liquid crystal display device. When transmittances of respective color pixels serving as a transmissive liquid crystal element are separately and independently controlled, the characteristics of the light emitted from the variable characteristic illumination device 136 can be controlled.

Hereinafter, it is assumed that the variable characteristic illumination device 136 includes six light sources whose emission luminances can be separately and independently varied. The respective six light sources are attached with filters whose spectral transmission characteristics are different from one another, thereby enabling emission of light having center emission wavelengths λ₁, λ₂, . . . , λ₆. However, this invention is not intended to be limited to this.

The spectrometer unit 138 can measure a spectrum of light illuminating the environment in which the display device 140 is observed. The spectrometer unit 138 is disposed in a position such that light from the variable characteristic illumination device 136 and the environment illuminant are incident thereon. For example, the spectrometer unit 138 is provided on an upper portion of the display device 140 or close to a sitting position of an observer observing an image displayed on the display device 140. Hereinafter, the light illuminating the environment in which the display device 140 is observed is referred to as observing illuminant. In other words, the observing illuminant includes the environment illuminant and the light from the variable characteristic illumination device 136. The spectrometer unit 138 includes: a hemispherical body 139 which is, for example, milky white and translucent; and a light receiving sensor (not shown) provided in an inner portion of the hemispherical body 139, thereby enabling measurement of a spectrum of the observing illuminant incident on the hemispherical body 139.

In order to enable the measurement of the spectrum of the observing illuminant, filters having different spectral transmission characteristics to each other can be provided on light receiving portions of a plurality of optical sensors. Alternatively, a turret with filters having different spectral characteristics to each other is attached to a light receiving portion of a single optical sensor to enable sequential switching among the filters. When levels of signals output from the respective optical sensors or levels of signals output in time series from the signal optical sensor are measured, the spectral characteristics of the observing illuminant incident on the hemispherical body 139 can be measured. A structure can also be employed in which the observing illuminant incident on the hemispherical body 139 is collimated into parallel light and guided to a grating. According to this structure, when the observing illuminant is diffracted and separated by the grating and received by a line sensor, the spectral characteristics of the observing illuminant can be measured based on a distribution (positions and intensities) of the observing illuminant incident on the line sensor.

A white balance sensor or a colorimeter which is functionally slightly inferior can also be provided as the spectrometer unit 138. When the white balance sensor is to be provided as the spectrometer unit 138, sensors for the respective colors of red, green, and blue are included in the inner portion of the hemispherical body 139. A color balance (color temperature) of the observing illuminant incident on the hemispherical body 139 is measured based on a level ratio among signals output from the respective sensors. Therefore, the spectrum of the observing illuminant incident on the hemispherical body 139 can be estimated based on the result obtained by the measurement. When the colorimeter is to be provided as the spectrometer unit 138, sensors, each of which has the same spectral sensitivity as the spectral sensitivity of a normal human eye, in other words,

x̅(λ), y̅(λ), z̅(λ)

or has a linear convertible relationship with the spectral sensitivity of a normal human eye, are included in the inner portion of the hemispherical body 139. The spectrum of the observing illuminant incident on the hemispherical body 139 can be estimated based on tristimulus values X, Y and Z obtained by those sensors. The spectrometer unit 138 outputs observing illumination spectrum information which is information relating to the result obtained by the measurement as described above to an illumination correction amount calculating unit 112 of the STB 102. The following description will be made based on the assumption that the spectrometer unit 138 can measure a spectrum in neighboring rages of six wavelengths λ₁, λ₂, . . . , λ₆ in a visible light of spectral band between 380 nm to 780 nm. As described above, various devices can be used for the spectrometer unit 138.

An internal structure of the STB 102 will be described. In FIG. 1, information and signals which are transmitted and received between respective constituent elements are expressed by information names and signal names, with parentheses. An input profile information separation unit 110 extracts, from the image signal input to the STB 102, input illuminant information, input device information, and M-band image data. Note that M is an integer equal to or larger than four. The above-mentioned input illuminant information and the above-mentioned input device information will be described. The input illuminant information relates to a spectral intensity distribution of the input illuminant illuminating an object when the object is photographed. When the image signal input to the STB 102 is an image signal generated by, for example, a computer graphics (CG), the input illuminant information is set according to the production intention of a producer by which the CG image is formed, and then input to the STB 102 together with the image signal. The input device information is information relating to spectral sensitive characteristics and gamma characteristics as the entire photographing device, which input device information being determined based on, for example, spectral transmission characteristics of a photographing lens attached to a photographing device used for photographing, spectral sensitivity of an image pickup device, and characteristics of a circuit for processing a signal output from the image pickup device to generate an image signal. The input profile information separation unit 110 outputs the input illuminant information to the illumination correction amount calculating unit 112, a combination of the input illuminant information and the input device information to a color conversion data calculating unit 114, and the M-band image data to a color conversion processing unit 118, respectively.

The color conversion data calculating unit 114 obtains calculation parameters used for color conversion processing of image data (hereinafter, referred to as “calculation parameters-1”) based on the input device information and the input illuminant information which are output from the input profile information separation unit 110, and then outputs the obtained calculation parameters-1 to the color conversion processing unit 118.

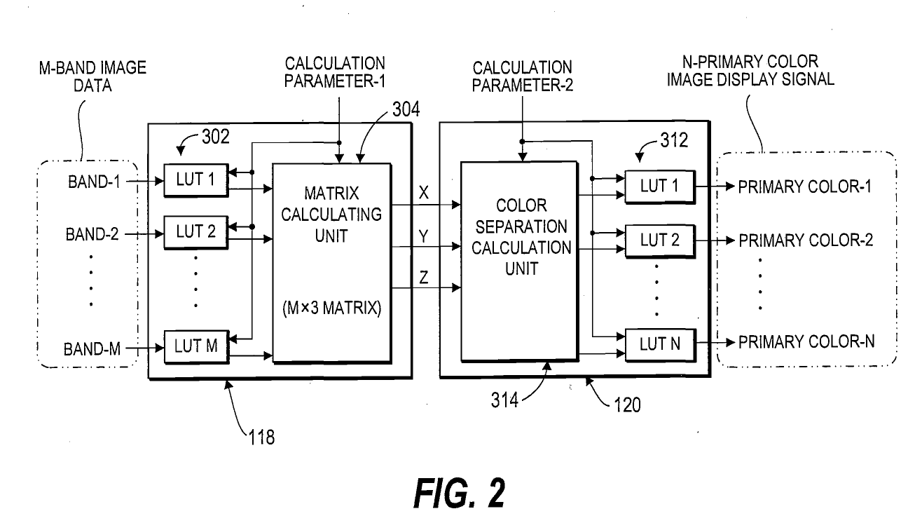

The color conversion processing unit 118 performs the color conversion processing on the M-band image data output from the input profile information separation unit 110 based on the calculation parameters-1 output from the color conversion data calculating unit 114, thereby generating three-band image signals of an X, Y, Z color system, in other words, colorimetric-value image signals. This processing will be described in detail later with reference to FIG. 2. Hereinafter, only an example will be described in which the color conversion processing unit 118 generates colorimetric-value image signals X, Y, and Z. An sRGB color system or an xvYCC color system may be used as signals generated by converting the M-band image data by the color conversion processing unit 118.

A monitor color conversion data calculating unit 116 obtains calculation parameters used to perform color conversion processing on the colorimetric-value image signals in a monitor color conversion data calculating unit 120 as described later (hereinafter, referred to as “calculation parameters-2”), based on monitor characteristic information output from the display device 140. Then, the monitor color conversion data calculating unit 116 outputs the obtained calculation parameters-2 to the monitor color conversion data calculating unit 120. The monitor characteristic information is information relating to, for example, chromaticity points of each of primary colors displayed on the display device, display tone characteristics, and a bias value (display surface luminance when input signal is zero).

The monitor color conversion data calculating unit 120 separates (converts) the colorimetric-value image signals X, Y, and Z which are output from the color conversion processing unit 118 into N-primary color image display signals and corrects the N-primary color image display signals based on gamma characteristics of the display device 140. The monitor color conversion data calculating unit 120 outputs the corrected image display signals to the display device 140. This processing will be described in detail later with reference to FIG. 2.

FIG. 2 is a detailed explanatory block diagram showing the color conversion processing unit 118 and the monitor color conversion processing unit 120. The color conversion processing unit 118 generates lookup tables (LUTs) LUT-1, LUT-2, . . . , LUT-M (hereinafter, collectively referred to as LUT 302″) and an M×3 matrix of a matrix calculating unit 304 based on the calculation parameters-1 input thereto. Of the calculation parameters-1, a parameter for generating the LUT 302 includes the gamma characteristics of the photographing device and information corresponding to the input device information such as an offset. A parameter for generating the M×3 matrix includes the respective information corresponding to the input illuminant information, the spectral sensitivity of the photographing device, and rendering illumination information. The rendering illumination information is information for specifying a spectrum of rendering illuminant. In this embodiment, the rendering illumination information specifies a spectrum substantially matched to the spectrum of the input illuminant. The LUT 302 and the M×3 matrix are used when the M-band image data input to the color conversion processing unit 118 is processed.

The LUT 302 is used to perform so-called tone curve correction on the respective M-band image data, thereby removing an affect of level and gamma characteristics of the photographing device. Subsequently, the matrix calculating unit 304 converts the M-band image data into colorimetric-value image signals X, Y, and Z by matrix calculation. The M-band image data is image data which includes spectrum information of the input illuminant and is affected by the spectral sensitive characteristics of the photographing device. Therefore, the input illuminant information and the input device information are used to calculate a spectral reflectance image signal of the object based on the M-band image data. The input illuminant may include, for example, not only light from an illumination light source provided in the photographing device but also light from the setting sun or artificial light whose spectrum is unevenly distributed. Even when the object is photographed in an environment including the above input illuminant, the matrix calculating unit 304 calculates spectral reflectance image signal of the object from which the above-mentioned effect, in other words, an effect caused by an uneven spectral distribution of the input illuminant is removed. Therefore, when the rendering illuminant having the spectrum specified by the rendering illumination information is applied to a spectral reflectance image signal of the object which is obtained based on the M-band image data, the input illuminant information, and the input device information, the colors of the object in any arbitrary illumination condition can be produced. In the embodiment of this invention, the color conversion processing unit 118 performs color conversion processing with the rendering illuminant such that a image with colors in a state in which the object is illuminated with the input illuminant, in other words, an image with colors which may be viewed if an observer is at a photographing location is displayed on the display device 140.

The monitor color conversion processing unit 120 generates a data table of a color separation calculation unit 314 and lookup tables (LUTs) LUT-1, LUT-2, . . . , LUT-N (hereinafter, collectively referred to as LUT 312″) based on the calculation parameters-2 input thereto. The data table and the LUT 312 are used when three-band image signals input to the monitor color conversion processing unit 120 is processed.

The data table of the color separation calculation unit 314 is used to separate the input three-band (X, Y, and Z) image signals into image display signals of primary color-1 to primary color-N. The LUT 312 is used to correct gamma characteristics of the display device 140. The data table of the color separation calculation unit 314 can include a 3×3 matrix in a case where the image display signals output to the display device 140 are of three primary colors. When the number of primary colors of the image display signals output to the display device 140 is equal to or larger than four, the color separation calculation unit 314 generates lookup tables for generating the image display signals of four or more primary colors based on the three-band image signals input to the monitor color conversion processing unit 120.

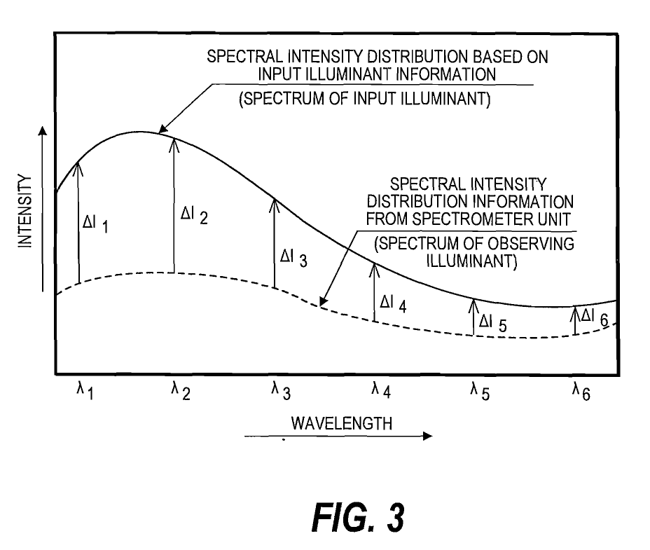

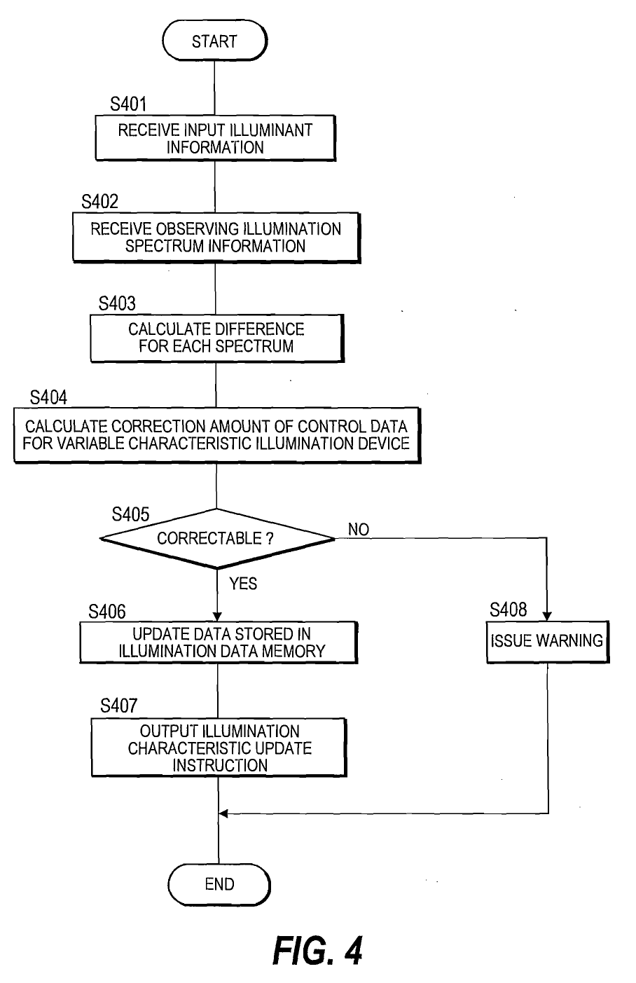

The description will be made again with reference to FIG. 1. The illumination correction amount calculating unit 112 receives the input illuminant information output from the input profile information separation unit 110 and information relating to the spectrum of the observing illuminant (hereinafter, referred to as “observing illumination spectrum information”) from the spectrometer unit 138. As described in detail later with reference to FIGS. 3 and 4, the illumination correction amount calculating unit 112 generates illumination correction information for substantially matching the spectrum of light illuminating the object in the photographing state (in other words, spectrum of input illuminant) with the spectrum of light illuminating the environment in which the display device 140 is observed (spectrum of observing illuminant), based on the observing illumination spectrum information and the input illuminant information. The illumination correction information is output to an illumination data memory 132 of the illumination control unit 130.

An illumination driver unit 134 independently adjusts power supplied to each of the plurality of light sources included in the variable characteristic illumination device 136, based on the illumination correction information stored in the illumination data memory 132 by an appropriate method suitable for the characteristics of the light sources, such as a current control method, a voltage control method, or a PWM control method, thereby controlling luminances and spectrums of light emitted from the variable characteristic illumination device 136.

FIG. 3 is a conceptual diagram showing a method of obtaining the illumination correction information in the illumination correction amount calculating unit 112 of FIG. 1. In FIG. 3, a curve indicated by a broken line exhibits the spectrum of the observing illuminant which is obtained by the spectrometer unit 138. As described above, the observing illuminant illuminates the environment in which the display device 140 is observed and includes the light emitted from the variable characteristic illumination device 136 and the environment illuminant. In FIG. 3, a curve indicated by a solid line exhibits the spectrum of the input illuminant which is obtained based on the input illuminant information. In the image display system 100 according to this invention, the characteristics of the light emitted from the variable characteristic illumination device 136 are adjusted to substantially match the spectrum of the observing illuminant to the spectrum of the input illuminant. The illumination correction amount calculating unit 112 calculates the illumination correction information for controlling the spectrum of the light emitted from the variable characteristic illumination device 136, based on a spectral difference between the spectrum of the input illuminant which is obtained from the input illuminant information and the spectrum of the observing illuminant which is obtained by the spectrometer unit 138. The calculated illumination correction information is output to the illumination data memory 132. In FIG. 3, ΔI₁, ΔI₂, . . . , and ΔI₆ correspond to illumination correction information.

FIG. 4 is a schematic flowchart showing an illumination correction information calculation processing procedure executed by the illumination correction amount calculating unit 112. When a moving image is displayed on the display device 140, the processing procedure shown in FIG. 4 can be called at relatively short intervals of, for example, 1/30 seconds or 1/60 second and then executed. Alternatively, the processing procedure can be called at longer intervals and then executed. The processing procedure may be called when a displayed image scene changes or when a change in input illuminant information is detected, and then executed. In contrast to this, when a still image is displayed on the display device 140, the processing procedure may be called when switching of the displayed image is detected, and then executed. When the input illuminant information includes change information (information indicating change of input illuminant), the processing procedure shown in FIG. 4 may be called based on the change information.

In Step S401, the illumination correction amount calculating unit 112 receives the input illuminant information from the input profile information separation unit 110. In Step S402, the illumination correction amount calculating unit 112 receives the observing illumination spectrum information from the spectrometer unit 138. In Step S403, the illumination correction amount calculating unit 112 calculates a difference for each spectrum (corresponding to ΔI₁, ΔI₂, . . . , ΔI₆ in FIG. 3) based on the input illuminant information (corresponding to the curve indicated by the solid line of FIG. 3) and the observing illumination spectrum information (corresponding to the curve indicated by the broken line of FIG. 3).

In Step S404, the illumination correction amount calculating unit 112 calculates new illumination correction information based on the difference for each spectrum which is calculated in Step S403 and the illumination correction information stored in the illumination data memory 132 during the previously executed processing procedure of FIG. 4. An example of the illumination correction information can include information having eight-bit control resolution for each of six light sources. In this case, the illumination. correction information corresponding to each of the six light sources can take any decimal value of 0 to 255. For example, it is assumed that a decimal value of 20 is stored as the illumination correction information corresponding to the light source having the center emission wavelength λ₁ in the illumination data memory 132 during the processing procedure of FIG. 4 which is previously executed. When a result obtained by the processing procedure of FIG. 4 which is currently executed shows that it is necessary to reduce the illumination correction information corresponding to the light source having the center emission wavelength λ₁ by 8, then a decimal value of 12 is newly stored as the illumination correction information corresponding to the light source having the center emission wavelength λ₁ in the illumination data memory 132. When the illumination correction information is calculated as described above, the intensity -of the light emitted from the variable characteristic illumination device 136 can be controlled with a closed loop. When the light emitted from the display device 140 is reflected on the observation environment, for example, a wall surface, a floor surface, or a ceiling in a room and then incident on the spectrometer unit 138, the variable characteristic illumination device 136 is controlled such that the affect of the light is reduced. Therefore, the spectrum of the observing illuminant can be more precisely matched to the spectrum of the input illuminant.

In Step S405, the illumination correction amount calculating unit 112 determines whether or not the observing illuminant can be corrected based on the illumination correction information calculated in Step S404. For example, when an image scene displayed on the display device 140 is dark, when the environment illuminant is too bright, or when the spectrum is unevenly distributed, it may be determined that the observing illuminant cannot be corrected even in a case where the luminance of at least one of the light sources of the variable characteristic illumination device 136 is set to 0 (non-light emission). When the determination in Step S405 is “NO”, the processing procedure branches to Step S408 to issue a warning. Then, the processing procedure of FIG. 4 is completed. A speaker unit for generating a sound or an indication device for emitting light can be provided in the STB 102 to issue the warning. Alternatively, the warning may be displayed on a display screen of the display device 140. When the observer recognizes the warning, the environment illumination device 152 can be turned off, a light intensity thereof can be reduced, or a curtain (not shown) on the window 150 can be closed.

When the determination in Step S405 is “YES”, in other words, when it is determined that the observing illuminant can be corrected by the variable characteristic illumination device 136, the processing procedure goes to Step S406. The illumination correction amount calculating unit 112 updates the illumination correction information stored in the illumination data memory 132 to a new value. In Step S407, the illumination correction amount calculating unit 112 outputs an updating instruction of an illumination characteristic to the illumination control unit 130. Then, the processing procedure of FIG. 4 is completed.

In response to the execution of Steps S406 and S407 in the illumination correction amount calculating unit 112, the illumination control unit 130 controls the variable characteristic illumination device 136 based on the updated illumination characteristic information to change the illumination characteristics thereof. After that, the processing procedure of FIG. 4 is repeatedly executed. Therefore, the illumination characteristic of the variable characteristic illumination device 136 is controlled such that the spectrum of the observing illuminant substantially matches to the spectrum of the input illuminant.

The case where it is determined that the observing illuminant cannot be corrected even when the luminance of at least one of the light sources of the variable characteristic illumination device 136 is set to 0 (non-light emission) is described as the case where the determination of Step S405 is “NO” with reference to FIG. 4. In contrast to this, there may be a case where the intensity of a light source included in the variable characteristic illumination device 136 cannot be further increased because the spectrum of the input illuminant is unevenly distributed or the intensity of the input illuminant is too large. Also in such a case, the illumination correction amount calculating unit 112 issues the warning. However, in order to prevent this state from frequently occurring, it is desirable to make the variable characteristic illumination device 136 to generate sufficient luminance (light beam).

In the first embodiment of this invention as described above, the example is described in which the warning is issued when the observing illuminant cannot be corrected by the variable characteristic illumination device 136. For example, a control unit for controlling the environment illumination device 152 can be provided in the STB 102. In this case, when the observing illuminant cannot be corrected by the variable characteristic illumination device 136, the environment illumination device 152 can be automatically turned off or the light intensity thereof can be automatically reduced. Alternatively, a structure may be employed in which a curtain or a blind which is attached to the window 150 can be automatically closed in response to a control signal output from the STB 102.

### Second Embodiment

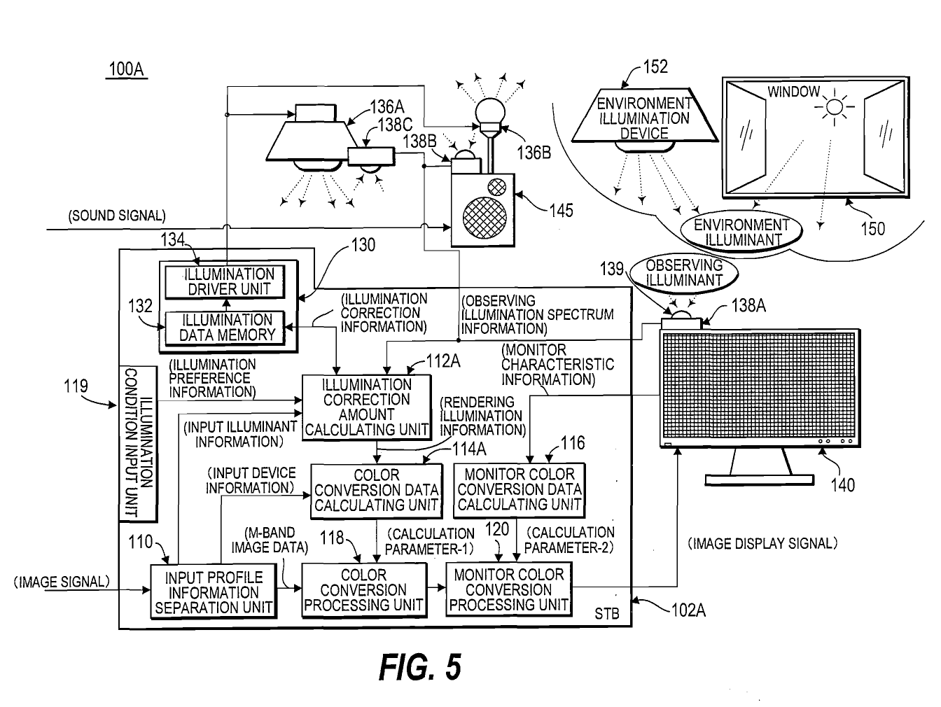

FIG. 5 is a schematic block diagram showing a structure of an image display system according to a second embodiment of this invention. In an image display system 100A shown in FIG. 5, the same constituent elements as those of the image display system 100 shown in FIG. 1 are denoted by the same reference symbols and the description thereof is omitted here. Points different from the image display system 100 shown in FIG. 1 will be mainly described.

The image display system 100 according to the first embodiment includes the single variable characteristic illumination device 136 and the single spectrometer unit 138. In contrast to this, the image display system 100A according to the second embodiment includes an STB 102A, a plurality of variable characteristic illumination devices 136A and 136B and a plurality of spectrometer units 138A, 138B, and 138C. FIG. 5 shows the example in which the two variable characteristic illumination devices and the three spectrometer units are provided. The number of variable characteristic illumination devices and the number of spectrometer units are not limited to the example shown in FIG. 5. The number of variable characteristic illumination devices may be equal to or different from the number of spectrometer units. The plurality of variable characteristic illumination devices 136A and 136B are connected to the illumination driver unit 134 of the illumination control unit 130 and controlled thereby. A spectrum of light emitted from the variable characteristic illumination device 136A can be made equal to or different from a spectrum of light emitted from the variable characteristic illumination device 136B. Various light sources such as a floor stand lamp, a pendant light, and a downlight can be used for the plurality of variable characteristic illumination devices. The image display system 100A includes a plurality of speakers 145 (FIG. 5 shows only single speaker unit) which can generate a surround acoustic field.

The plurality of spectrometer units 138A, 138B, and 138C can be disposed to various locations of the environment in which the display device 140 is provided, including not only the upper portion of the display device 140 but also the vicinity of the ceiling and an upper portion of the speaker 145. The plurality of spectrometer units 138A, 138B, and 138C are connected with an illumination correction amount calculating unit 112A. The illumination correction amount calculating unit 112A performs processing such as simple averaging or weighted averaging based on the observing illumination spectrum information output from the spectrometer units 138A, 138B, and 138C. Therefore, it is possible to obtain spectrums of light present not only in the surroundings of the display device 140 but also in an environment around an observer viewing an image displayed on the display device 140. The variable characteristic illumination device 136B can be provided on the speaker 145 as shown in FIG. 5.

When the variable characteristic illumination device 136B and the spectrometer unit 138B are to be set on the speaker 145 as described above, a signal line and a power supply cable can be provided together with a speaker cable. The observing illumination spectrum information output from the spectrometer unit 138B can also be superimposed on a sound signal and transmitted through a speaker cable. A power line communication (PLC) technique can also be used to transmit a sound signal and the observing illumination spectrum information through a power line.

In the image display system 100 according to the first embodiment, the color conversion data calculating unit 114 receives the input device information and the input illuminant information from the input profile information separation unit 110. In contrast to this, in the image display system 100A according to the second embodiment, the input illuminant information from the input profile information separation unit 110 is input only to the illumination correction amount calculating unit 112A. The input device information from the input profile information separation unit 110 is input to a color conversion data calculating unit 114A. Unlike the image display system 100 according to the first embodiment, the input illuminant information is not input to the color conversion data calculating unit 114A. The color conversion data calculating unit 114A determines the calculation parameters-1 based on the rendering illumination information output from the illumination correction amount calculating unit 112A and the input device information output from the input profile information separation unit 110 and outputs the calculation parameters-1 to the color conversion processing unit 118. An illumination condition input unit 119 and illumination preference information output from the illumination condition input unit 119 to the illumination correction amount calculating unit 112A will be described later.

The image display system 100 shown in FIG. 1 is different in structure from the image display system 100A shown in FIG. 5 in the points described above. The operation of the image display system 100A will be described mainly with respect to the difference from the operation of the display image system 100.

In the example shown in FIG. 3 with respect to the image display system 100 according to the first embodiment, the spectrum of the input illuminant exceeds the spectrum of the observing illuminant at all wavelengths. In such a case, in the image display system 100, the spectrum of the light emitted from the variable characteristic illumination device 136 is adjusted to substantially match the spectrum of the input illuminant with the spectrum of the rendering illuminant. In contrast to this, while the spectrums of the light emitted from the variable characteristic illumination devices 136A and 136B can be adjusted to substantially match the spectrum of the input illuminant with the spectrum of the observing illuminant, the image display system 100A according to the second embodiment performs the same operation as the image display system 100 according to the first embodiment. At this time, the rendering illumination information output from the illumination correction amount calculating unit 112A to the color conversion data calculating unit 114A is substantially equal to the input illuminant information.

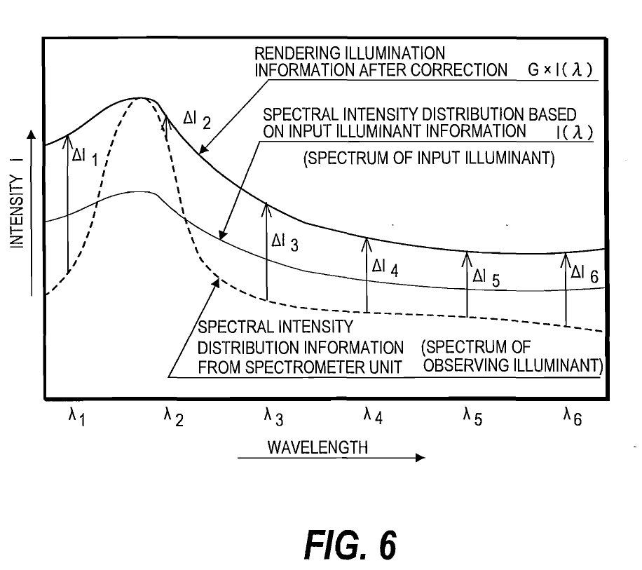

FIG. 6 is a conceptual diagram showing a method of obtaining the illumination correction information and the rendering illumination information in the illumination correction amount calculating unit 112A of FIG. 5. In FIG. 6, a curve indicated by a broken line exhibits the spectrum of the observing illuminant which is obtained by the spectrometer units 138A, 138B, and 138C. As in the case of the first embodiment, the observing illuminant illuminates the environment in which the display device 140 is observed and includes the light emitted from the variable characteristic illumination devices 136A and 136B and the environment illuminant. In FIG. 6, a curve indicated by a thinner solid line exhibits a spectrum I(λ) of the input illuminant which is obtained based on the input illuminant information. The illumination correction amount calculating unit 112A determines the illumination correction information for controlling the spectrums of the light emitted from the variable characteristic illumination devices 136A and 136B, based on a spectral difference between the spectrum of the input illuminant which is obtained from the input illuminant information and the spectrum of the observing illuminant which is obtained by the spectrometer units 138A, 138B, and 138C. The illumination correction information is output to the illumination data memory 132.

In the state shown in FIG. 6, there is a region in which the spectrum of the environment illuminant exceeds the spectrum of the input illuminant (region close to wavelength λ₂). This is a state in which the warning is issued in the image display system 100 according to the first embodiment. In the image display system 100A according to the second embodiment, the illumination correction amount calculating unit 112A generates, as corrected rendering illumination information (rendering illumination information after correction) “G×I(λ)”, the spectrum I(λ) of the input illuminant which is multiplied by a gain G (dB) in the state as shown in FIG. 6 (corrected rendering illumination information is indicated by thicker solid line of FIG. 6). This prevents the corrected rendering illumination information “G×I(λ)” from becoming lower than the spectrum of the observing illuminant. The corrected rendering illumination information is output from the illumination correction amount calculating unit 112A to the color conversion data calculating unit 114A. The color conversion data calculating unit 114A calculates the calculation parameters-1 based on the input device information output from the input profile information separation unit 110 and the corrected rendering illumination information and then outputs the calculation parameters-1 to the color conversion processing unit 118.

In the state in which the spectrum of the observing illuminant exceeds the spectrum of the input illuminant in at least a part of the wavelength band as shown in FIG. 6, the illumination correction amount calculating unit 112A performs the above-mentioned processing to increase a luminance of an image displayed on the display device 140. At this time, the spectrum I(λ) of the input illuminant is multiplied by the same gain G (dB) in each wavelength of the wavelength band, so the luminance of the image displayed on the display device 140 increases but no color balance changes. In other words, it is maintained that a state in which a relative spectrum of the input illuminant is substantially matched to a relative spectrum of corrected rendering illuminant. The illumination correction amount calculating unit 112A determines illumination correction amounts ΔI₁, ΔI₂, . . . , ΔI₆ such that the spectrum of the observing illuminant is substantially matched to the spectrum of the corrected rendering illuminant. The illumination correction amounts are output to the illumination data memory 132. Hereinafter, the gain G (dB) by which the spectrum I(λ) of the input illuminant is multiplied is referred to as a rendering gain. Information (G×I(λ)) obtained by multiplying the spectrum I(λ) of the input illuminant by the rendering gain G is referred to as corrected rendering illumination information.

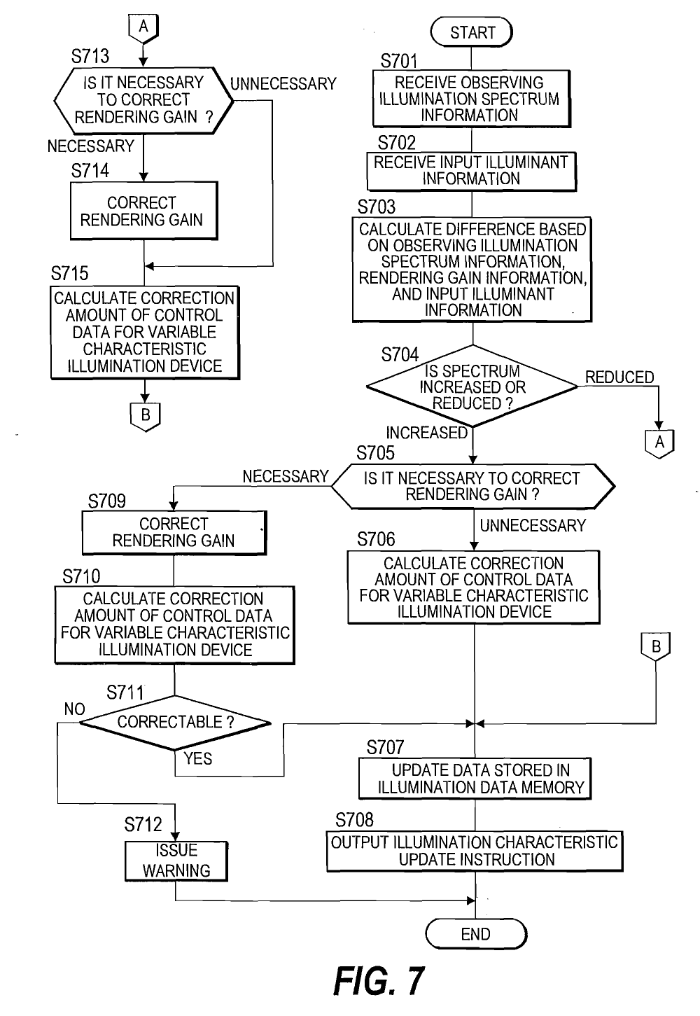

FIG. 7 is a schematic flowchart showing a procedure of processing for calculating the illumination correction information and the rendering gain, which is executed by the illumination correction amount calculating unit 112A. When a moving image is displayed on the display device 140, the processing procedure shown in FIG. 7 can be called at relatively short intervals of, for example, 1/30 seconds or 1/60 seconds and then executed. Alternatively, the processing procedure can be called at longer intervals and then executed. The processing procedure may be called when a displayed image scene changes or when the change in input illuminant information is detected, and then executed. In contrast to this, when a still image is displayed on the display device 140, the processing procedure may be called when switching of a displayed image is detected, and then executed.

In Step S701, the illumination correction amount calculating unit 112A receives the observing illumination spectrum information from the spectrometer units 138A, 138B, and 138C. In Step S702, the illumination correction amount calculating unit 112A receives the input illuminant information from the input profile information separation unit 110. In Step S703, the illumination correction amount calculating unit 112A calculates a difference for each spectrum based on the above-mentioned input illuminant information (corresponding to the curve indicated by the thinner solid line of FIG. 6), the observing illumination spectrum information (corresponding to the curve indicated by the broken line of FIG. 6), and the rendering gain which is currently set.

In Step S704, the illumination correction amount calculating unit 112A determines whether or not the spectrum of the observing illuminant increases at least one of the wavelengths λ₁ to λ₆, based on the differences calculated in Step S703. When it is determined that even a part of the spectrum increases, the processing procedure branches to Step S705. In Step S705, whether or not it is necessary to correct the rendering gain is determined. In the example shown in FIG. 6, the following determination is made.
(1) Even in a case where the spectrum of the observing illuminant does not change at the wavelength λ₂ and components of the spectrum of the observing illuminant slightly increase at wavelengths other than λ₂, as long as the components of the spectrum thereof do not exceed the corrected rendering illumination information “G×I(λ)” set at the preceding stage, it is determined that it is unnecessary to correct the rendering gain.
(2) Even in a case where the components of the spectrum of the observing illuminant increase at the wavelengths other than λ₂ but are lower than the corrected rendering illumination information “G×I(λ)” set at the preceding stage, as long as a peak at a wavelength close to λ₂ lowers, it is determined that it is necessary to correct the rendering gain (it is necessary to reduce the rendering gain in this case).
(3) In a case where the spectrum of the observing illuminant increases at the wavelength λ₂ (peak value increases at wavelength close to λ₂ of FIG. 6), even when the spectrum of the observing illuminant is reduced at the other wavelengths, it is determined that it is necessary to correct the rendering gain (it is necessary to increase the rendering gain in this case).

When it is determined in Step S705 that it is unnecessary to correct the rendering gain, the processing procedure branches to Step S706. In Step S706, the illumination correction amount calculating unit 112A calculates new illumination correction information based on the difference for each spectrum which is calculated in Step S703 and the illumination correction information stored in the illumination data memory 132 during the previously executed processing procedure of FIG. 7. In Step S707, the illumination correction amount calculating unit 112A updates the illumination correction information stored in the illumination data memory 132 to a new value. In Step S708, the illumination correction amount calculating unit 112A outputs an illumination characteristic update instruction to the illumination control unit 130. Then, the processing procedure of FIG. 7 is completed.

When it is determined in Step S705 that it is necessary to correct the rendering gain, the processing procedure branches to Step S709. In Step S709, the illumination correction amount calculating unit 112A corrects the rendering gain. In Step S710, the illumination correction amount calculating unit 112A calculates a correction amount of control data for each of the variable characteristic illumination devices based on the difference for each spectrum which is calculated in Step S703, the illumination correction information stored in the illumination data memory 132 during the previously executed processing procedure of FIG. 7, and the rendering gain obtained in Step S709.

In Step S711, the illumination correction amount calculating unit 112A determines whether or not the rendering gain and the illumination correction information can be corrected, based on the results obtained in. Steps S709 and S710. When the determination is “YES”, the processing procedure branches to Step S707. On the other hand, when the determination in Step S711 is “NO”, for example, when it is determined that the luminance of the image displayed on the display device 140 cannot further increase and thus the rendering gain cannot further increase, the processing procedure branches to Step S712 to issue a warning. Then, the processing procedure is completed.

When it is determined in Step S704 that the spectrum of the observing illuminant is reduced at the wavelengths λ₁ to λ₆, based on the illumination correction information calculated in Step S703, the processing procedure branches to Step S713. In Step S713, the illumination correction amount calculating unit 112A determines whether or not it is necessary to correct the rendering gain.

In the example shown in FIG. 6, the determination in Step S713 is made as follows.
(1) In a case where the spectrum of the observing illuminant does not change at the wavelength λ₂, even when the spectrum of the observing illuminant is reduced at the wavelengths other than λ₂, it is determined that it is unnecessary to correct the rendering gain.
(2) When the components of the spectrum of the observing illuminant are reduced at all the wavelengths including the wavelength λ₂, it is determined that it is necessary to correct the rendering gain (it is necessary to reduce the rendering gain in this case).

When it is determined in Step S713 that it is necessary to correct the rendering gain, the processing procedure branches to Step S714. In Step S714, the illumination correction amount calculating unit 112A corrects the rendering gain. Specifically, the rendering gain is corrected to prevent the spectrum of the observing illuminant from exceeding the corrected rendering illumination information “G×I(λ)” at the wavelengths λ₁ to λ₆ and to minimize the rendering gain. On the other hand, when it is determined in Step S713 that it is unnecessary to correct the rendering gain, in other words, when the spectrum of the observing illuminant does not change at the wavelength λ₂, the processing procedure branches to Step S715.

In Step S715, the illumination correction amount calculating unit 112A calculates a correction amount of control data for each of the variable characteristic illumination devices based on the difference for each spectrum which is calculated in Step S703 and the illumination correction information stored in the illumination data memory 132 during the previously executed processing procedure of FIG. 7. When the rendering gain is corrected in Step S714, the corrected rendering gain is also taken into account to calculate the correction amount of control data. After that, Steps S707 and S708 are executed.

According to the processing of the illumination correction amount calculating unit 112A which is described with reference to FIGS. 6 and 7, when the spectrum of the observing illuminant exceeds the spectrum of the input illuminant at at least one of the wavelengths λ₁ to λ₆, the spectrum I(λ) of the input illuminant is multiplied by a predetermined rendering gain G to obtain the corrected rendering illumination information “G×I(λ)”. The corrected rendering illumination information is output as the rendering illumination information to the color conversion data calculating unit 114A. The color conversion data calculating unit 114A calculates the calculation parameters-1 based on the rendering illumination information. The color conversion processing unit 118 performs the color conversion processing on the M-band image data output from the input profile information separation unit 110 based on the calculation parameters-1 output from the color conversion data calculating unit 114A, thereby generating, for example, the three-band image signals of the X, Y, Z color system, in other words, the colorimetric-value image signals. The rendering illumination information is used to generate the colorimetric-value image signals. Therefore, when the rendering gain G increases as described above, the luminance of the image displayed on the display device 140 increases. Thus, even when the observing illuminant is slightly bright or even when uneven color balance occurs, the image display system 100A can display a realistic image and control the observing illuminant. Even when the environment illuminant changes while the image displayed on the display device 140 is observed, the observing illuminant can be controlled corresponding to the change by the processing of FIG. 7. For example, even when light entering through the window 150 is reddened in the evening or even when the environment illumination device 152 is turned off or turned on, the observing illuminant can be controlled. Therefore, a more realistic image can be displayed.

In the example described with reference to FIGS. 6 and 7, when a part of the spectrum of the environment illuminant is larger than the spectrum of the input illuminant, the spectral intensity of the rendering illuminant increases without the change in color balance of the displayed image. When the spectral intensity of the rendering illuminant is to increase, the color balance of the displayed image can be made different from that of an original image. For example, as described below, the color balance can be set corresponding to the preferences of an observer observing the image.

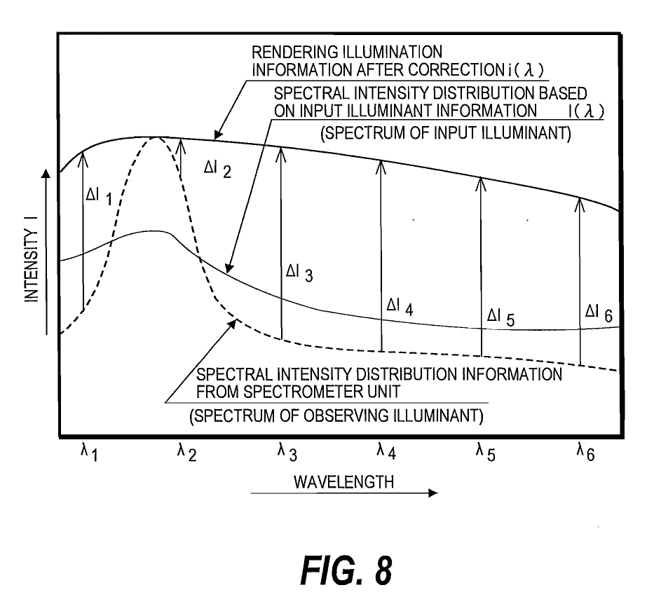

This example will be described with reference to FIGS. 5, 8 and 9. In FIG. 5, the observer can operate the illumination condition input unit 119 to freely set the color balance for the rendering illumination (spectral relative values). For example, the color balance of the image of the object photographed with illuminating light such as tungsten light can be set to a color balance which may be obtained in a case where the object is photographed with sunlight or light emitted from a fluorescent lamp. Information relating to the spectral relative values set by the observer (hereinafter, referred to as “illumination preference information”) is input to the illumination correction amount calculating unit 112A. When a part of the spectrum of the observing illuminant is larger than the spectrum of the input illuminant, as shown in FIG. 8, the method of applying the rendering gain G which is described earlier with reference to FIGS. 6 and 7 is not used. Instead, corrected rendering illumination information (rendering illumination information after correction) i(λ) is set based on the illumination preference information set by (output from) the illumination condition input unit 119 operated by the observer.

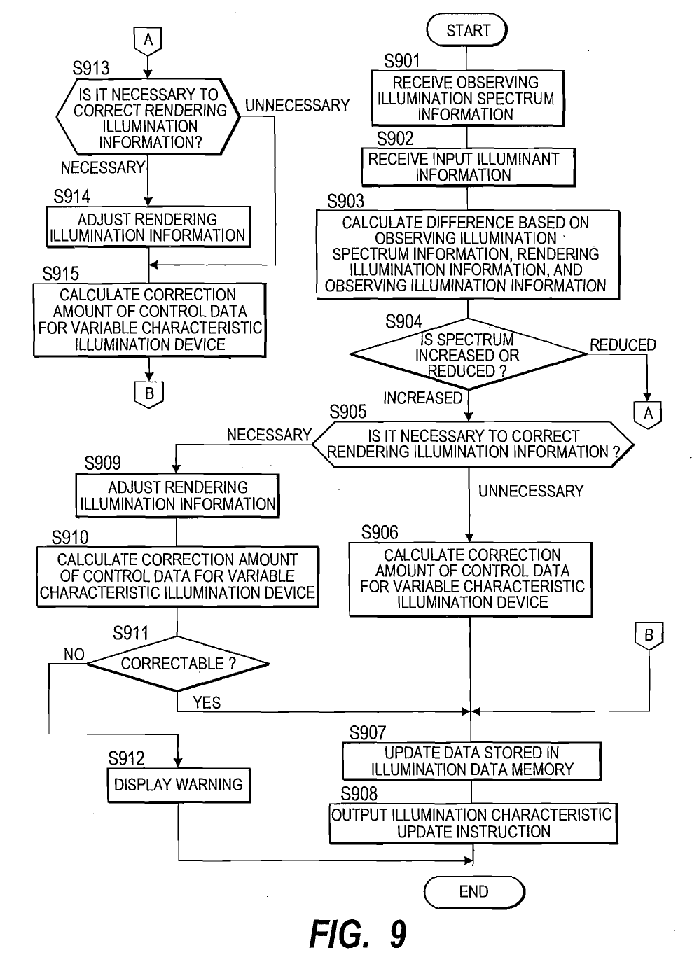

FIG. 9 is a schematic flowchart showing another example of a procedure of processing for calculating the illumination correction information and the rendering illumination information, which is executed by the illumination correction amount calculating unit 112A. As in the processing procedure shown in FIG. 7, when a moving image is displayed on the display device 140, the processing procedure shown in FIG. 9 can be called at relatively short intervals of, for example, 1/30 seconds or 1/60 seconds and then executed. Alternatively, the processing procedure can be called at longer intervals and then executed. The processing procedure may be called when a displayed image scene changes or when the change in input illuminant information is detected, and then executed. In contrast to this, when a still image is displayed on the display device 140, the processing procedure may be called when switching of a displayed image is detected, and then executed.

In Step S901, the illumination correction amount calculating unit 112A receives the observing illumination spectrum information from the spectrometer units 138A, 138B, and 138C. In Step S902, the illumination correction amount calculating unit 112A receives the input illuminant information from the input profile information separation unit 110. In Step S903, the illumination correction amount calculating unit 112A calculates a difference for each spectrum based on the input illuminant information (corresponding to a curve indicated by a thinner solid line of FIG. 8), the observing illumination spectrum information (corresponding to a curve indicated by a broken line of FIG. 8), and the rendering illumination information which is currently set.

In Step S904, the illumination correction amount calculating unit 112A determines whether or not a part of the spectrum of the observing illuminant increases at at least one of the wavelengths λ₁ to λ₆, based on the differences calculated in Step S903. When it is determined that the part of the spectrum increases, the processing procedure branches to Step S905. In Step S905, whether or not it is necessary to correct the rendering illumination information is determined. In the example shown in FIG. 8, the following determination is made.
(1) Even in a case where the spectrum of the observing illuminant does not change at the wavelength λ₂ and components of the spectrum of the observing illuminant slightly increase at wavelengths other than λ₂, as long as the components of the spectrum thereof do not exceed the corrected rendering illumination information i(λ) set at the preceding stage, it is determined that it is unnecessary to correct the rendering illumination information.
(2) Even in a case where the components of the spectrum of the observing illuminant increase at the wavelengths other than λ₂ but are lower than the corrected rendering illumination information i(λ) set at the preceding stage, as long as a peak at a wavelength close to λ₂ lowers, it is determined that it is necessary to correct the rendering illumination information (it is necessary to correct the rendering illumination information to reduce the corrected rendering illumination information i(λ) in this case).
(3) In a case where the spectrum of the observing illuminant increases at the wavelength λ₂ (peak value increases at wavelength close to λ₂ of FIG. 8), even when the spectrum of the observing illuminant is reduced at the other wavelengths, it is determined that it is necessary to correct the rendering illumination information (it is necessary to correct the rendering illumination information to increase the corrected rendering illumination information i(λ) in this case).

When it is determined in Step S905 that it is unnecessary to correct the rendering illumination information, the processing procedure branches to Step S906. In Step S906, the illumination correction amount calculating unit 112A calculates new illumination correction information based on the difference for each spectrum which is calculated in Step S903 and the illumination correction information stored in the illumination data memory 132 during the processing procedure of FIG. 9 which is previously executed. In Step S907, the illumination correction amount calculating unit 112A updates the illumination correction information stored in the illumination data memory 132 to a new value. In Step S908, the illumination correction amount calculating unit 112A outputs an illumination characteristic update instruction to the illumination control unit 130. Then, the processing procedure of FIG. 9 is completed.

When it is determined in Step S905 that it is necessary to correct the rendering illumination information, the processing procedure branches to Step S909. In Step S909, the illumination correction amount calculating unit 112A adjusts the rendering illumination information. In Step S910, the illumination correction amount calculating unit 112A calculates new illumination correction information based on the difference for each spectrum which is calculated in Step S903, the illumination correction information stored in the illumination data memory 132 during the previously executed processing procedure of FIG. 9, and the rendering illumination information obtained (adjusted) in Step S909. The correction of the rendering illumination information which is performed in Step S909 will be described here. The illumination correction information is determined so as to hold the spectral relative values of the rendering illumination (maintain color balance) which is set by the observer. Therefore, the rendering illuminant is increased or reduced based on the intensity of the spectrum of the observing illuminant while a relative spectral intensity distribution of the rendering illuminant is maintained.

In Step S911, the illumination correction amount calculating unit 112A determines whether or not the rendering illumination information and the illumination correction information can be corrected, based on the results obtained in Steps S909 and S910. When the determination is “YES”, the processing procedure branches to Step S907. On the other hand, when the determination in Step S911 is “NO”, for example, when it is determined that the luminance of the image displayed on the display device 140 cannot further increase and thus the rendering illumination information cannot be further adjusted, the processing procedure branches to Step S912 to issue a warning. Then, the processing procedure is completed.

When it is determined in Step S904 that the spectrum of the observing illuminant is reduced at the wavelengths λ₁ to λ₆, based on the illumination correction information calculated in Step S903, the processing procedure branches to Step S913. In Step S913, the illumination correction amount calculating unit 112A determines whether or not it is necessary to adjust the rendering illumination information. In the example shown in FIG. 8, the following determination is made.
(1) In a case where the spectrum of the observing illuminant does not change at the wavelength λ₂, even when the spectrum of the observing illuminant is reduced at the wavelengths other than λ₂, it is determined that it is unnecessary to correct the rendering illumination information.
(2) When the components of the spectrum of the observing illuminant are reduced at all the wavelengths including the wavelength λ₂, it is determined that it is necessary to correct the rendering illumination information (it is necessary to correct the rendering illumination information to reduce the corrected rendering illumination information i(λ) in this case).

When it is determined in Step S913 that it is necessary to correct the rendering illumination information, the processing procedure branches to Step S914. In Step S914, the illumination correction amount calculating unit 112A corrects the rendering illumination information. Specifically, the rendering illumination information is corrected to prevent the spectrum of the observing illuminant from exceeding the corrected rendering illumination information i(λ) at the wavelengths λ₁ to λ₆ and to minimize a rendering correction amount. In the case where the rendering illumination information is adjusted in Step S914, when the spectrum of the observing illuminant is lower than the spectrum I(λ) of the input illuminant in the entire wavelength band, the corrected rendering illumination information i(λ) can be set to be equal to the spectrum I(λ) of the input illuminant. When it is determined in Step S913 that it is unnecessary to correct the rendering illumination information, in other words, when the spectrum of the observing illuminant does not change at the wavelength λ₂, the processing procedure branches to Step S915.

In Step S915, the illumination correction amount calculating unit 112A calculates new illumination correction information based on the difference for each spectrum which is calculated in Step S903 and the illumination correction information stored in the illumination data memory 132 during the previously processed procedure of FIG. 9. When the rendering illumination information is corrected in Step S914, the corrected rendering illumination information is also taken into account to calculate the new illumination correction information. After that, Steps S907 and S908 are executed.

According to the processing of the illumination correction amount calculating unit 112A which is described with reference to FIGS. 8 and 9, when the spectrum of the observing illuminant exceeds the spectrum of the input illuminant at at least one of the wavelengths λ₁ to λ₆, the correction amount of the rendering illumination is determined so as to maintain the relative spectral values of the rendering illumination which is set by the observer, and then output as the rendering illumination information to the color conversion data calculating unit 114A. The color conversion data calculating unit 114A calculates the calculation parameters-1 based on the rendering illumination information. The color conversion processing unit 118 performs the color conversion processing on the M-band image data output from the input profile information separation unit 110 based on the calculation parameters-1 output from the color conversion data calculating unit 114A, thereby generating, for example, the three-band image signals of the X, Y, Z color system, in other words, the colorimetric-value image signals. The rendering illumination information is used to generate the colorimetric-value image signals. Therefore, the rendering illuminant set by the observer is applied to the image displayed on the display device 140. Thus, even when the observing illuminant is slightly bright or even when uneven color balance occurs, the display of the image applied with the rendering illumination and the control of the observing illuminant can be performed corresponding to the preferences of the observer by the image display system 100A. Even when the environment illuminant changes while the image displayed on the display device 140 is observed, the observing illuminant can be controlled corresponding to the change by the processing of FIG. 9.

As described in the first and second embodiments of this invention, the set top boxes (STBs) 102 and 102A can be provided as devices independently separated from the display device 140. The STB may be incorporated in the display device 140. The STB may be incorporated in a device connected with the display device 140, such as a video recorder. Examples of the display device 140 which can be employed include a flat display, a field emission display, a rear projection type display, and a projector, each of which has a display element such as a liquid crystal element, a PDP element, or an organic EL element.

The image display technology according to this invention can be used for a television receiver, a video monitor display device, a monitor display device for a computer, and an image display system including an image projection device such as a data projector.

It will be appreciated that variations in and modifications to the embodiments as described and illustrated may be made within the scope of this application as defined in the appended claims.

The entire contents of Japanese Patent Application No. 2007-178338 (filed on Jul. 6, 2007) are incorporated herein by reference.

What is claimed is:

1. An image display processing apparatus which
receives input illuminant information which is information relating to a spectrum of input illuminant illuminating an object during photographing, input device information which is input characteristic information of a photographing device used for the photographing, and an object image signal obtained by photographing the object with the photographing device,
performs color conversion processing by applying rendering light having a spectrum substantially matched with the spectrum of the input illuminant to a spectral reflectance image signal of the object which is calculated based on the object image signal, the input illuminant information, and the input device information, to generate an image display signal to be output to a display device, and
controls a spectrum of light emitted from a variable characteristic illumination device which is configured to illuminate an environment, in which the display device is observed, with light having a desired spectrum,
wherein the image display processing apparatus is configured to:
receive observing illumination spectrum information from a spectrometer unit which measures observing illuminant for illuminating the environment in which the display device is observed and generating observing illumination spectrum information, the observing illumination spectrum information being information relating to a spectrum of the observing illuminant; and
adjust the spectrum of the light emitted from the variable characteristic illumination device to substantially match the spectrum of the input illuminant and the spectrum of the observing illuminant.

2. An image display processing apparatus which
receives input illuminant information which is information relating to a spectrum of input illuminant illuminating an object during photographing, input device information which is input characteristic information of a photographing device used for the photographing, and an object image signal obtained by photographing the object with the photographing device,
performs color conversion processing by applying rendering light to a spectral reflectance image signal of the object which is calculated based on the object image signal, the input illuminant information, and the input device information, to generate an image display signal to be output to a display device, and
controls a spectrum of light emitted from a variable characteristic illumination device which is configured to illuminate an environment, in which the display device is observed, with light having a desired spectrum,
wherein the image display processing apparatus is configured to:
receive observing illumination spectrum information from a spectrometer unit which measures observing illuminant for illuminating the environment in which the display device is observed and generating observing illumination spectrum information, the observing illumination spectrum information being information relating to a spectrum of the observing illuminant;
determine a spectrum of the rendering light so as to substantially match with the spectrum of the input illuminant; and
adjust the spectrum of the light emitted from the variable characteristic illumination device to substantially match the spectrum of the rendering light and the spectrum of the observing illuminant.

3. The image display processing apparatus according to claim 2, further being configured to
determine whether or not it is possible to substantially match the spectrum of the rendering light and the spectrum of the observing illuminant by adjusting the spectrum of the light emitted from the variable characteristic illumination device, and further adjust the spectrum of the rendering light to substantially match the spectrum of the rendering light and the spectrum of the observing illuminant when it is determined that it is not possible to substantially match the spectra of both the rendering light and the observing illuminant.

4. The image display processing apparatus according to claim 3, wherein
the spectrum of the rendering light is adjusted in such a manner that relative spectra of both the input illuminant and the rendering light after the adjustment are substantially matched.

5. The image display processing apparatus according to claim 3, wherein
the spectrum of the rendering light is adjusted such that the relative spectrum of the adjusted spectrum of the rendering light is substantially matched with a preset relative spectrum.

6. An image display processing apparatus which performs color conversion on an object image signal obtained by photographing an object with a photographing device and outputs the object image signal to a display device, comprising:
an input profile information separation unit for obtaining input illuminant information which is information relating to a spectrum of input illuminant illuminating the object during photographing, input device information which is input characteristic information of the photographing device used for the photographing, and the object image signal;
a signal processing unit for performing color conversion processing by applying rendering light having a spectrum substantially matched with the spectrum of the input illuminant to a spectral reflectance image signal of the object which is calculated based on the object image signal, the input illuminant information, and the input device information, and generating an image display signal to be output to the display device;
an illumination correction amount calculating unit for calculating illumination correction information based on a difference between the input illuminant information output from the input profile information separation unit and observing illumination spectrum information output from a spectrometer unit which measures a spectrum of observing illuminant illuminating an environment in which the display device is observed, the observing illumination spectrum information being information relating to a spectrum of the observing illuminant; and
an illumination control unit for adjusting a spectrum of light emitted from a variable characteristic illumination device based on the illumination correction information to substantially match the spectrum of the input illuminant and the spectrum of the observing illuminant, the variable characteristic illumination device illuminating the environment in which the display device is observed, with light having a desired spectrum.

7. An image display processing apparatus which performs color conversion on an object image signal obtained by photographing an object with a photographing device and outputs the object image signal to a display device, comprising:
an input profile information separation unit for obtaining input illuminant information which is information relating to a spectrum of input illuminant illuminating the object during photographing, input device information which is input characteristic information of the photographing device used for the photographing, and the object image signal;
a signal processing unit for performing color conversion processing by applying rendering light to a spectral reflectance image signal of the object which is calculated based on the object image signal, the input illuminant information, and the input device information, and generating an image display signal to be output to the display device;
an illumination correction amount calculating unit for calculating illumination correction information based on a difference between the input illuminant information output from the input profile information separation unit and observing illumination spectrum information output from a spectrometer unit which measures a spectrum of observing illuminant illuminating an environment in which the display device is observed, the observing illumination spectrum information being information relating to a spectrum of the observing illuminant, and determining rendering illumination information for controlling a spectrum of the rendering light based on the difference; and
an illumination control unit for adjusting a spectrum of light emitted from a variable characteristic illumination device based on the illumination correction information to substantially match the spectra of both the rendering light and the observing illuminant, the variable characteristic illumination device illuminating the environment in which the display device is observed, with light having a desired spectrum.

8. An image display system, comprising:
a display device;
an image display processing apparatus for performing color conversion on an object image signal obtained by photographing an object with a photographing device and outputting the object image signal to the display device;
a spectrometer unit for measuring a spectrum of observing illuminant illuminating an environment in which the display device is observed; and
a variable characteristic illumination device which is configured to illuminate an environment, in which the display device is observed, with light having a desired spectrum,
wherein the image display processing apparatus includes:
an input profile information separation unit for obtaining input illuminant information which is information relating to a spectrum of input illuminant illuminating the object during photographing, input device information which is input characteristic information of the photographing device used for the photographing, and the object image signal;
a signal processing unit for performing color conversion processing by applying rendering light having a spectrum substantially matched with the spectrum of the input illuminant to a spectral reflectance image signal of the object which is calculated based on the object image signal, the input illuminant information, and the input device information, and generating an image display signal to be output to the display device;
an illumination correction amount calculating unit for calculating illumination correction information based on a difference between the input illuminant information output from the input profile information separation unit and observing illumination spectrum information which is information relating to the spectrum of the observing illuminant and being output from the spectrometer unit; and
an illumination control unit for adjusting a spectrum of light emitted from the variable characteristic illumination device based on the illumination correction information to substantially match the spectra of both the input illuminant and the spectrum of the observing illuminant.

9. An image display system, comprising:
a display device;
an image display processing apparatus for performing color conversion on an object image signal obtained by photographing an object with a photographing device and outputs the object image signal to the display device;
a spectrometer unit for measuring a spectrum of observing illuminant illuminating an environment in which the display device is observed; and
a variable characteristic illumination device which is configured to illuminate an environment, in which the display device is observed, with light having a desired spectrum,
wherein the image display processing apparatus includes:
an input profile information separation unit for obtaining input illuminant information which is information relating to a spectrum of input illuminant illuminating the object during photographing, input device information which is input characteristic information of the photographing device used for the photographing, and the object image signal;
a signal processing unit for performing color conversion processing by applying rendering light to a spectral reflectance image signal of the object which is calculated based on the object image signal, the input illuminant information, and the input device information, to generate an image display signal to be output to the display device;
an illumination correction amount calculating unit for calculating illumination correction information based on a difference between the input illuminant information output from the input profile information separation unit and observing illumination spectrum information which is information relating to the spectrum of the observing illuminant and being output from the spectrometer unit, and determining rendering illumination information for controlling a spectrum of the rendering light based on the difference; and
an illumination control unit for adjusting a spectrum of light emitted from the variable characteristic illumination device based on the illumination correction information to substantially match the spectra of both the rendering light and the observing illuminant.

10. The image display system according to claim 9, wherein
the image display processing apparatus determines whether or not it is possible to substantially match the spectra of both the rendering light and the observing illuminant by adjusting the spectrum of the light emitted from the variable characteristic illumination device, and further adjusts the spectrum of the rendering light when it is determined that it is not possible to substantially match the spectra of both the rendering light and the observing illuminant.

11. An image display processing method, comprising:
receiving input illuminant information which is information relating to a spectrum of input illuminant illuminating an object during photographing, input device information which is input characteristic information of a photographing device used for the photographing, and an object image signal obtained by photographing the object with the photographing device;
performing color conversion processing by applying rendering light having a spectrum substantially matched with the spectrum of the input illuminant to a spectral reflectance image signal of the object which is calculated based on the object image signal, the input illuminant information, and the input device information, to generate an image display signal to be output to a display device;
measuring observing illuminant which is light illuminating an environment in which the display device is observed, to obtain observing illumination spectrum information which is information relating to a spectrum of the observing illuminant; and
adjusting a spectrum of light emitted from a variable characteristic illumination device which is configured to illuminate an environment, in which the display device is observed, with light having a desired spectrum, to substantially match the spectra of both the input illuminant and the observing illuminant.

12. An image display processing method, comprising:
receiving input illuminant information which is information relating to a spectrum of input illuminant illuminating an object during photographing, input device information which is input characteristic information of a photographing device used for the photographing, and an object image signal obtained by photographing the object with the photographing device;
performing color conversion processing by applying rendering light to a spectral reflectance image signal of the object which is calculated based on the object image signal, the input illuminant information, and the input device information, to generate an image display signal to be output to a display device;
measuring observing illuminant which is light illuminating an environment in which the display device is observed, to obtain observing illumination spectrum information which is information relating to a spectrum of the observing illuminant;
calculating illumination correction information based on a difference between the observing illumination spectrum information and the input illuminant information and determining rendering illumination information for adjusting a spectrum of the rendering light based on the difference; and
adjusting a spectrum of light emitted from a variable characteristic illumination device which is configured to illuminate environment, in which the display device is observed, with light having a desired spectrum, to substantially match the spectra of both the rendering light and the observing illuminant.

13. The image display processing method according to claim 12, further comprising:
determining whether or not it is possible to substantially match the spectrum of the rendering light and the spectrum of the observing illuminant by adjusting the spectrum of the light emitted from the variable characteristic illumination device; and
further adjusting the spectrum of the rendering light when it is determined that it is not possible to substantially match the spectrum of the rendering light and the spectrum of the observing illuminant.
